(19) United States
(12) Patent Application Publication
(10) Pub. No.: US 2011/0304121 A1
(43) Pub. Date: Dec. 15, 2011

(54) QUICK-RELEASE MECHANISM

(75) Inventor: Chien-Liang CHIU, Taipei (TW)

(73) Assignee: WU'S TECH CO., LTD., Hsinchu City (TW)

(21) Appl. No.: 12/813,862

(22) Filed: Jun. 11, 2010

(51) Int. Cl. A61G 5/10

(52) U.S. Cl. 280/304.1

(57) ABSTRACT

The present invention provides a quick-release mechanism of assembly structure, of which said quick-release mechanism includes an exterior sleeve, expansion link sections, a threading portion of driving section, elastic part and a brake. The expansion link sections are arranged at interval into the holding space of the exterior sleeve. At least one elastic part is arranged into the holding space of the exterior sleeve, enabling retraction or protruding of the expansion link sections. The present invention is characterized in that the driving section of the brake is mated with the threading portion of driving section, so that the brake can drive the expansion link section to control the actuating state of the positioning end in either positioning or release mode. With this configuration, the users can dismantle or operate the device easily in either positioning or release mode.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a quick-release mechanism, and more particularly to an innovative one which enables assembly, positioning and disengagement of an assembly structure and wheelchair.

2. Description of Related Art Including Information Disclosed Under 37 CFR 1.97 and 37 CFR 1.98.

The currently available wheelchairs are categorized into human-operated and electrical wheelchairs. In order to meet the expectations of the users who intend to update human-operated wheelchair to electrical one without any waste, an auxiliary drive device has been developed and installed onto existing wheelchairs for driving auxiliarily its movement.

However, it is observed from actual application that, the assembly structure of said auxiliary drive device is inconvenient to be combined with or disengaged from the wheelchair, so there is still a big room for improvement. In the present invention, a quick-release mechanism enables assembly, positioning and disengagement of the assembly structure and wheelchair, making it possible to transport, store and carry the wheelchair, or when the auxiliary drive device cannot be used in special circumstances, it can be disassembled, allowing it to resume the operating state of a human-operated wheelchair so as to meet the user demands.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The enhanced efficacy of the present invention is as follows:

The “quick-release mechanism” of the present invention mainly comprises an exterior sleeve, expansion link section, elastic part and brake. It is characterized in that the driving section of the brake can drive the expansion link section, making it in a positioning or release state. With this simple structure, the users can dismantle or operate the device easily in either positioning or release mode.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the quick-release mechanism of the present invention.

FIG. 2 shows a schematice view of the quick-release mechanism of the present invention.

FIG. 3 shows a perspective view wherein the quick-release mechanism of the present invention is mounted at the assembly position.

FIG. 4 shows a schematic view of the assembly structure and wheelchair of the present invention in combination with an auxiliary drive device and wheelchair.

FIG. 5 shows a sectional view wherein the quick-release mechanism of the present invention is mounted at the assembly position.

FIG. 6 shows a sectional view wherein the quick-release mechanism of the present invention is disengaged from the assembly position.

### DETAILED DESCRIPTION OF THE INVENTION

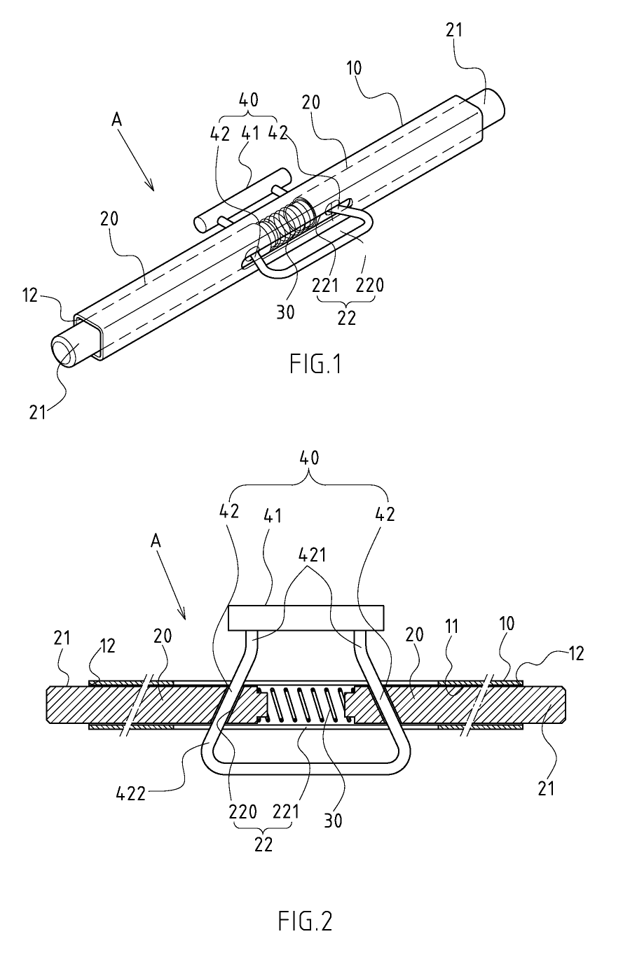

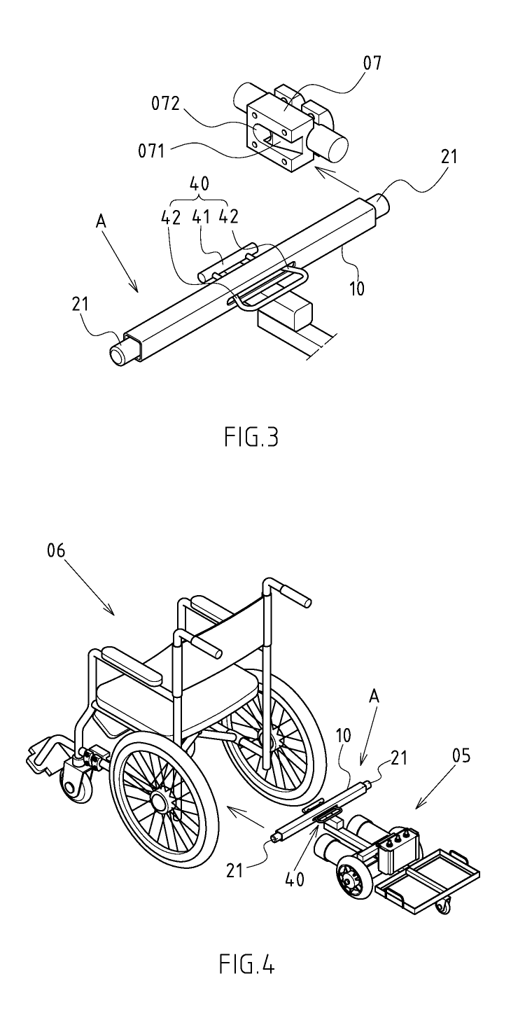

FIGS. 1 and 2 depict preferred embodiments of a quick-release mechanism of assembly structure of the present invention, which, however, are provided for only explanatory objective for patent claims. Said assembly structure 05 is mounted onto the assembly position 07 of a wheelchair 06 (shown in FIGS. 3, 4), while the quick-release mechanism A is used to control the positioning and release mode of the assembly structure 05 and wheelchair 06. Said quick-release mechanism A includes an exterior sleeve 10 in a hollow shape, used to define a holding space 11 and two end ports 12.

Two expansion link sections 20 are arranged at interval into the holding space 11 of the exterior sleeve 10. A positioning end 21 is formed externally onto the expansion link section 20, and can be protruded from the end port 12 of the exterior sleeve 10.

A threading portion of driving section 22 includes a driven portion 220 and a through-hole 221. The driven portion 220 is arranged onto the expansion link section 20, and the through-hole 221 passes through the exterior sleeve 10.

At least one elastic part 30 is arranged into the holding space 11 of the exterior sleeve 10, enabling resettability of the expansion link section 20.

A brake 40 includes an adjusting portion 41 and two driving sections 42. These two driving sections 42 are extended obliquely and symmetrically to define a tapered reducing end 421 and a tapered expanding end 422. The adjusting portion 41 is formed at either tapered reducing end 421 or tapered expanding end 422 of two driving sections 42. These two driving sections 42 are sleeved vertically onto the threading portion of driving section 22 in a limited state.

When the adjusting portion 41 of the brake 40 is pushed, the driving section 42 of said brake 40 is mated with the driven portion 220 of the threading portion of driving section 22, such that the brake 40 can push the expansion link section 20 to control the actuating state of the positioning end 21 in a positioning or release mode.

Of which, the adjusting portion 41 is formed at the tapered reducing end 421 of two driving sections 42, and the elastic part 30 is linked to inner ends of two expansion link sections 20, such that the expansion link section 20 is pushed elastically towards the end port 12 of the exterior sleeve 10. When the adjusting portion 41 of the brake 40 is pressed, the expansion link section 20 is in a recessed state, such that the positioning end 21 of the expansion link section 20 is disengaged from the assembly position 07, and the elastic part 30 is pressed to accumulate elastic force. When the pressing state is released, the expansion link section 20 is pushed elastically by the elastic part 30 to move outwards.

Referring to FIGS. 3, 4 and 5, the assembly position 07 is provided with an oblique guide surface 071 and a lateral positioning port 072. When the quick-release mechanism A of said assembly structure 05 and the assembly position 07 are in a positioning state, the positioning end 21 of the expansion link section 20 is abutted onto the oblique guide surface 071, and the quick-release mechanism A is pushed towards the lateral positioning port 072, such that the expansion link section 20 can apply the oblique guide surface 071 to press the elastic part 30 for accumulating the elastic force. When the positioning end 21 of the expansion link section 20 is smoothly slid into said lateral positioning port 072 by passing the oblique guide surface 071, the elastic force of the elastic part 30 is released to push two expansion link sections 20 outwards and position securely onto the lateral positioning port 072, so the assembly structure 05 and wheelchair 06 can be positioned. As the assembly structure 05 as an auxiliary drive device can be combined with the wheelchair in a positioning state.

Based on above-specified structural configuration, the present invention is operated as follows:

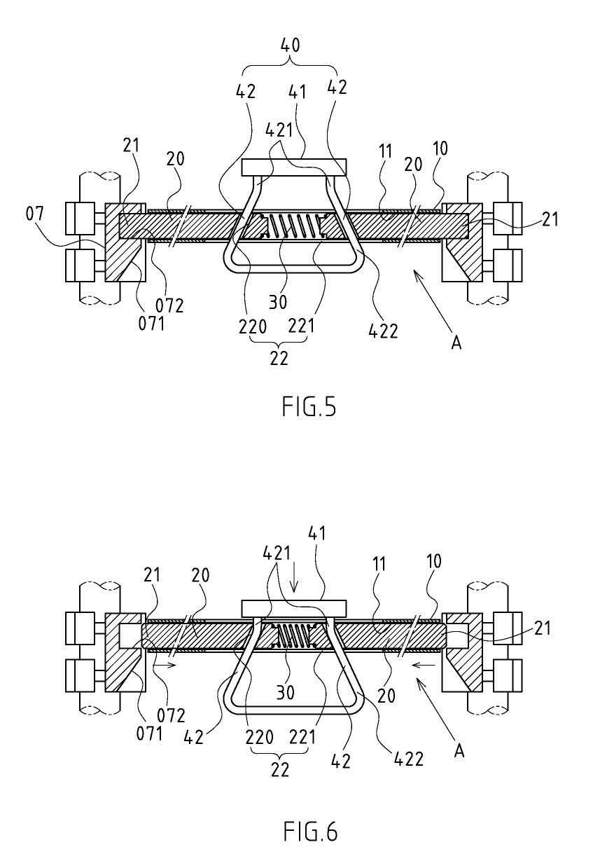

The assembly state of said quick-release mechanism A and assembly position 07 is shown in FIG. 5. When the assembly structure 05 is to be disassembled (as shown in FIG. 6), the adjusting portion 41 of the brake 40 is pressed so that the driving section 42 can be mated with the expansion link section 20, making the expansion link section 20 in a retraction state. Then, the positioning end 21 of the expansion link section 20 is disengaged from the lateral positioning port 072 of the assembly position 07, so the auxiliary drive device can be shifted out of the wheelchair in a release state.

Additionally, the technical characteristics of the present invention are described in detail. In the preferred embodiments of the present invention, the adjusting portion 41 is formed at the tapered reducing end 421 of two driving sections 42, or at tapered expanding end 422 of two driving sections 42. In such a case, the brake 40 can be released in a reverse way (by pulling the adjusting portion 41 other than by pressing the adjusting portion 41), thus dismantling easily the assembly structure 05.

1. A quick-release mechanism of assembly structure, wherein said assembly structure is mounted onto the assembly position of a wheelchair, and the quick-release mechanism is used to control the positioning and release mode of the assembly structure and wheelchair; said quick-release mechanism comprising at least:
an exterior sleeve having a hollow shape, used to define a holding space and two end ports;
two expansion link sections; arranged at interval into the holding space of the exterior sleeve; a positioning end is formed externally onto the expansion link section, and can be protruded from the end port of the exterior sleeve;
a threading portion of driving section; including a driven portion and a through-hole; the driven portion is arranged onto the expansion link section, and the through-hole passes through the exterior sleeve;
at least one elastic part arranged into the holding space of the exterior sleeve, enabling resettability of the expansion link section;
a brake including an adjusting portion and two driving sections; these two driving sections are extended obliquely and symmetrically to define a tapered reducing end and a tapered expanding end; the adjusting portion is formed at either tapered reducing end or tapered expanding end of two driving sections; these two driving sections are sleeved vertically onto the threading portion of driving section in a limited state;
when the adjusting portion of the brake is pushed, the driving section of said brake is mated with the driven portion of the threading portion, such that the brake can push the expansion link section to control the actuating state of the positioning end in positioning or release mode.

2. The structure defined in claim 1, wherein the adjusting portion is formed at the tapered reducing end of two driving sections, and the elastic part is linked to inner ends of two expansion link sections, such that the expansion link section is pushed elastically towards the end port of the exterior sleeve; when the adjusting portion of the brake is pressed, the expansion link section is in a recessed state, and the elastic part is pressed to accumulate elastic force; when the pressing state is released, the expansion link section is pushed elastically by the elastic part to move outwards.

3. The structure defined in claim 1, wherein the driven portion of the threading portion is configured to be mated with the driving section of the brake, and the driven portion aligns with the through-hole of the exterior sleeve.

4. The structure defined in claim 1, wherein the assembly position is provided with an oblique guide surface and lateral positioning port.

5. The structure defined in claim 1, wherein said assembly structure is mainly used as an auxiliary drive device.
